(19) United States
(12) Patent Application Publication
(10) Pub. No.: US 2005/0175954 A1
(43) Pub. Date: Aug. 11, 2005

(54) Mandibular-repositioning devices

(76) Inventor: Adrian Karl Zacher, Aylesbury, Buckinghamshire (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/512,785

(22) PCT Filed: Apr. 28, 2003
(86) PCT No.: PCT/GB03/01796

(30) Foreign Application Priority Data
Apr. 27, 2002 (GB) 0209668.3

(51) Int. Cl. A61C 3/00

(52) U.S. Cl. 433/5

(57) ABSTRACT

A mandibular-repositioning diagnostic device has an extra-oral mechanism (3) in which an apertured frame (6) and an arm (7) are attached respectively to upper- and lower-jaw trays (1,2), and the arm (7) is coupled via a ratchet-toothed strap (13) to a slider-carrier (16) retained within the frame-aperture (17). Pulling the strap (13) through a latching head (18) on the carrier (16) reduces incrementally the spacing between the arm (7) and frame (6). A ratchet-toothed strap (25) extending lengthwise of the aperture (17) from the carrier (16), is pulled through a latching head (29) on the frame (6) to draw the carrier (16), and with it the arm (7) and lower-jaw tray (2), incrementally forwards relative to the upper-jaw tray (1). The carrier (16) is movable transversely of the aperture (17) to allow lateral-movement between the patient's jaws. The optimum setting of the mechanism (3) found, is fixed by adhesively attaching intercoupled links (4,5) to the frame (6) and arm (7) before they are uncoupled from the trays (1,2) and used as a jig for permanent oral-device manufacture.

This invention relates to mandibular-repositioning devices.

Mandibular repositioning is used in the reduction of snoring and treatment of sleep apnoea, and in this context involves use by the patient of an oral device which is designed to assist breathing by retaining the lower jaw and tongue forward. The forward location of the jaw and tongue keeps the airway space in the throat open, and is believed to tension the soft palate and the pharyngeal walls.

The degree of mandibular repositioning required, or indeed whether repositioning would be effective, to overcome the disorder or reduce its effect without causing discomfort or distress to the patient from wearing the device itself, or side effects from its use, is not open to ready or reliable diagnosis. Accordingly, there is the disadvantage that it may be necessary to proceed through a series of lengthy trial stages, each requiring the manufacture and fitting to the patient of an individual mandibular-repositioning device, before a satisfactory device providing the optimum degree of repositioning can be provided, or indeed the benefit of such a device in the patient's case, can be determined.

It is an object of the present invention to provide a form of mandibular-repositioning device that may be used to reduce this disadvantage.

According to the present invention there is provided a mandibular-repositioning device wherein first and second parts for engagement with a patient's upper and lower jaws respectively are intercoupled via an extra-oral mechanism, said mechanism being selectively operable for incremental change of the displacement of the second part forwardly relative to the first part.

The mandibular-repositioning device of the present invention facilitates diagnosis by avoiding the economic and other burdens of time and cost of manufacture and fitting of a series of devices in determining the optimum repositioning required, or indeed whether repositioning will be of benefit. A significant advantage of the device, moreover, is that the mechanism involved is located extra-orally and operates incrementally so that repositioning adjustments can be made with precision and minimum discomfort and distress to the patient.

The mechanism of the mandibular-repositioning device of the invention may include ratchet means that is selectively operable for effecting the incremental change of the displacement. The ratchet means may comprise a flexible strap having ratchet teeth, and a latching head through which the strap passes and which latches resiliently with successive teeth of the strap as the strap is advanced incrementally in one direction through the head. A further ratchet means, which may similarly comprise a flexible strap and a latching head for latching resiliently with ratchet teeth of the strap, may be incorporated in the mechanism for adjustment of spacing between the first and second parts.

A mandibular-repositioning device according to the invention will now be described, by way of example, with reference to the accompanying drawings, in which:

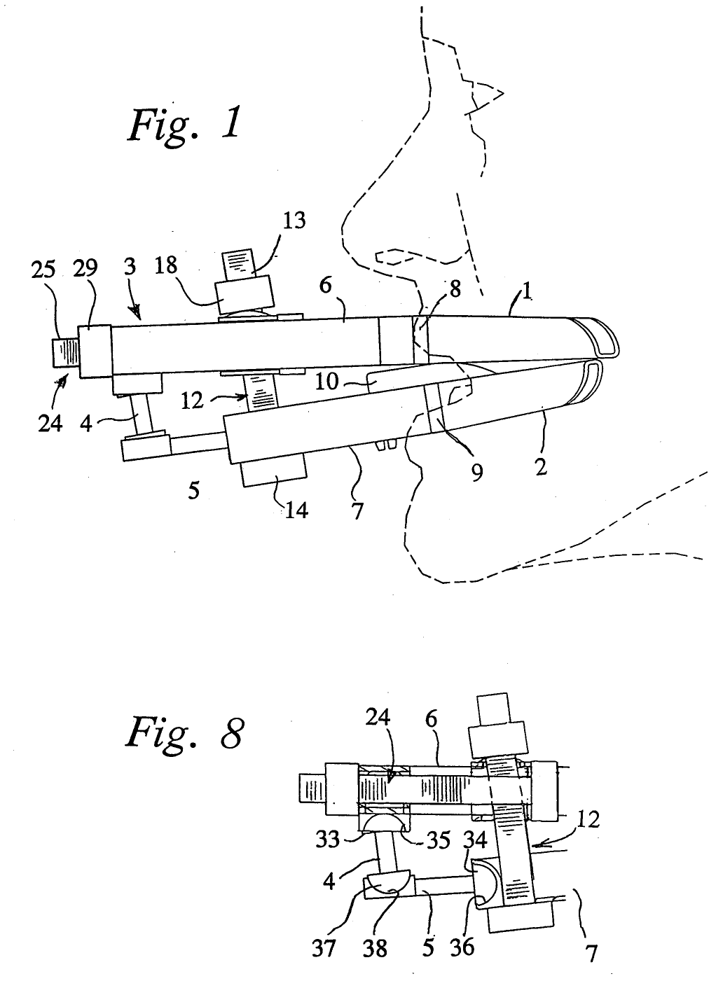

FIG. 1 is a side view of the mandibular-repositioning device of the invention illustrated in a diagnostic context;

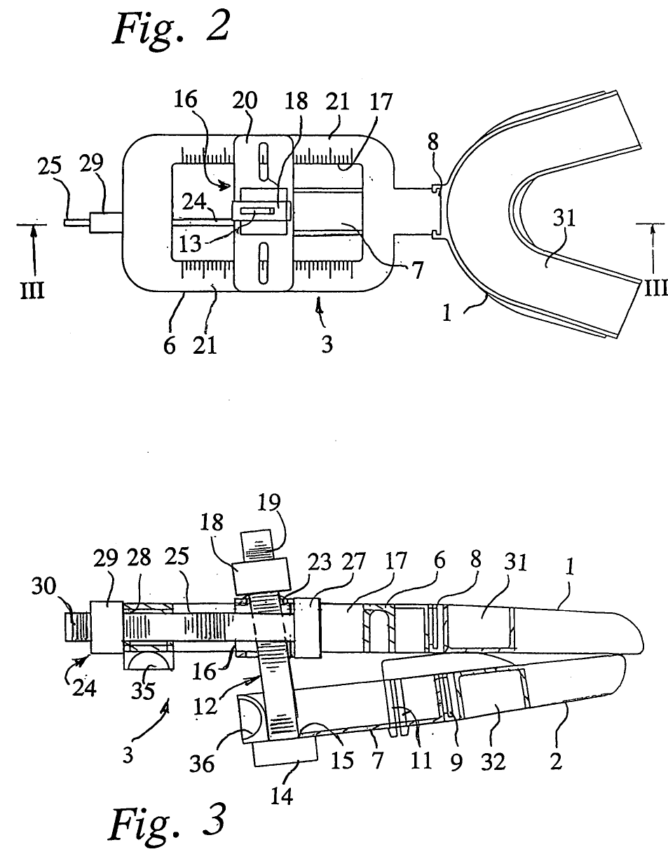

FIG. 2 is a plan view from above of the mandibular-repositioning device of the invention;

FIG. 3 is sectional side elevation of the mandibular-repositioning device of FIG. 2, the section being taken on the line III-III of FIG. 2;

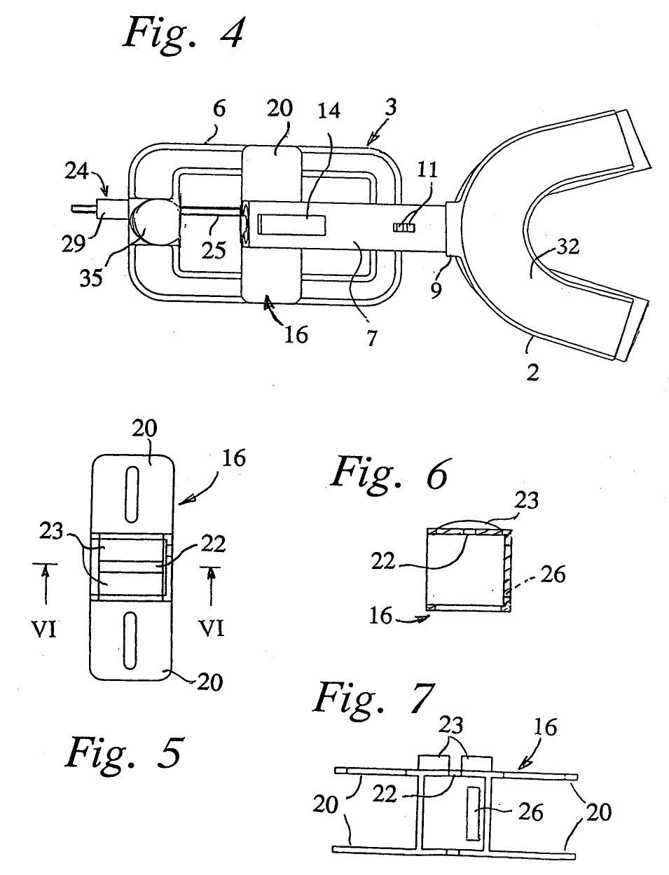

FIG. 4 is a plan view from below of the mandibular-repositioning device of FIG. 2;

FIGS. 5 to 7 are, respectively, a plan view from above, a sectional side elevation taken on the line VI-VI of FIG. 5, and a front view, all to enlarged scale, of a slider-carrier of the mandibular-repositioning device of the invention; and

FIG. 8 is illustrative of the use of links to fix the setting of the mandibular-repositioning device once adjustment of it has been concluded.

Referring to FIG. 1, the mandibular-repositioning device includes upper and lower trays 1 and 2 that are engaged by the patient's upper and lower jaws respectively, within the mouth. The trays 1 and 2 are intercoupled extra-orally by a mechanism 3 that enables the relationship between them to be adjusted. The mechanism 3 is in this regard selectively operable for incremental adjustment of both the angular disposition and the forward displacement of the lower tray 2 relative to the upper tray 1. It is by these adjustments that the patient's lower jaw can be repositioned in stages during a period of diagnosis. The setting of the mechanism 3, and therefore the extent of repositioning imposed, can be increased progressively over a period of nights, firstly to determine whether repositioning is appropriate or effective for treatment of the patient's snoring or sleep apnoea, and secondly, if it is, to determine the optimum setting effective and tolerable for the patient. Once the optimum setting has been determined, links 4 and 5 are secured to the mechanism 3 to fix that setting in it and enable the mechanism 3 to be removed and used as a jig in the manufacture of a more-permanent form of oral device for regular use by the patient.

The construction of the device of FIG. 1 will now be described in more detail with reference also to FIGS. 2 to 4.

Referring to FIGS. 1 to 4, the upper and lower trays 1 and 2, which are of moulded plastics material, are of U- and inverted-U cross-section respectively, for conformity with the patient's upper and lower sets of teeth. The mechanism 3 intercoupling the trays land 2 includes an elongate, rectangular frame 6 and an elongate arm 7 that project forwardly from the trays 1 and 2 out of the patient's mouth. The frame 6 and arm 7, which are of moulded plastics material and have U- and inverted-U cross-sections respectively, are held securely to the trays 1 and 2 via individual, releasable slide-couplings 8 and 9.

A spacer block 10, which has legs 11 that clip resiliently into the arm 7, projects backwardly from between the frame 6 and arm 7 to hold the trays 1 and 2 spaced apart and provide an anterior bite avoiding posterior contact. Pivotal spacing of the arm 7 from the frame 6 about the block 10, is determined by a plastics tie 12 that involves an elongate flexible strap 13. The strap 13, which has an enlarged head 14 holding it fast within a slot 15 of the arm 7, extends upwardly from the arm 7 through a slider-carrier 16 that is slidable lengthwise of an elongate, central aperture 17 of the frame 6. A latching head 18 of the tie 12 is threaded onto the strap 13 where it exits the carrier 16 and latches resiliently with successive ratchet teeth 19 of the strap 13. The latching of the head 18 with the teeth 19 is such that the strap 13 can be pulled with ratchet action upwards through the carrier 16 so as to pivot the arm 7 towards the frame 6 incrementally, but not in the reverse direction; a small lever (not shown) in the head 18 needs to be depressed in order to release the latching with the teeth 19 and free the strap 13 to pass through the head 18 in the reverse direction.

Referring now also to FIGS. 5 to 7 the carrier 16 is a plastics moulding of generally H-section that is retained within the frame 6 with its limbs 20 straddling the two longitudinal sides 21 of the aperture 17; there is room for a small degree of movement of the carrier 16 transversely of the aperture 17. The strap 13 passes through a slot 22 that is flanked on the top of the carrier 16 by shoulders 23. Tensioning of the strap 13 pulls the head 18 down onto the shoulders 23 which are of curved contour to allow the set tension to be maintained under longitudinal displacement of the arm 7 relative to the frame 6.

Longitudinal displacement of the arm 7 relative to the frame 6 is regulated by a plastics tie 24 that is active between the slider-carrier 16 and the frame 6. In this regard, the tie 24 involves an elongate flexible strap 25 that is retained fast within a slot 26 (FIG. 7) of the carrier 16 by its enlarged head 27, and extends from the carrier 16 lengthwise of the aperture 17 to exit through a slot 28 of the frame 6. A latch head 29 of the tie 24 is threaded onto the strap 25 where it exits the slot 28 and latches resiliently with successive ratchet teeth 30 of the strap 25. The latching of the head 29 is such that the strap 25 can be pulled incrementally with ratchet action through the head 29, in the direction away from the frame 6 but not in the reverse direction; a small lever (not shown) in the head 29 needs to be depressed in order to release the latching with the teeth 30 and free the strap 25 to pass through the head 29 in the reverse direction.

Thus, simply by pulling the strap 25 through the head 29 away from the frame 6, the carrier 16, and with it the arm 7 and tray 2, are advanced forwardly with respect to the tray 1. The ratchet action enables the advance to be made accurately in small incremental steps, and the upper limbs 20 of the carrier 16 are apertured to facilitate measurement of the forward displacement of the lower tray 2 with respect to the upper tray 1, against graduations on the sides 21 of the frame 6.

In preparation for use of the device, channels 31 and 32 of the trays 1 and 2 are first filled with thermoplastic-acrylic or other dental impression-material, and the block 10 removed. After the filled trays 1 and 2 have been dipped in hot water they are entered into the patient's mouth for him/her to bite onto and set the acrylic material to give good and comfortable engagement of the trays 1 and 2 with his/her upper and lower jaws. The block 10 is now returned and the strap 13 is pulled tight through the head 18 to whatever extent is deemed appropriate in limiting freedom for vertical movement between the trays 1 and 2 in opening and closing of the patient's mouth.

Repositioning of the patient's lower jaw can now be effected, simply by pulling on the strap 25 to ratchet the lower tray 2 forwardly one or more increments as an initial setting appropriate for trial over one or more nights. The flexibility of the straps 13 and 25 laterally of the mechanism 3 and the room for movement of the carrier 16 transversely of the aperture 17, allows for small lateral displacements of the arm 7 relative to the frame 6 during the trial. Furthermore, the patient can remove the device from his/her mouth and replace it whenever desired without affecting the setting established by the ties 12 and 24. After trial with the initial setting has taken place, the setting can be readily changed to increase the forward displacement for further trial simply by ratcheting the strap 24 forwardly one or more increments. This process can be repeated until the optimum setting has been determined and the manufacture and fitting of a permanent device for mandibular repositioning becomes economically justified and of assured, worthwhile therapeutic benefit.

Once the optimum setting has been achieved this is fixed in the mechanism 3 by engaging the links 4 and 5 with the frame 6 and arm 7 and with one another as illustrated in FIGS. 1 and 8. In this regard, and as shown more clearly by FIG. 8, the links 4 and 5 have ball-ends 33 and 34 for engagement with individual sockets 35 and 36 of the frame 6 and arm 7, and the link 4 has a further ball-end 37 for engagement with a socket-end 38 of the link 5. Once the engagements have been made, the links 4 and 5 are locked together and to the frame 6 and arm 7 using a strong, quick-drying adhesive. This holds the mechanism 3 in its setting so that when it is uncoupled from the trays 1 and 2, it can be used as a jig for accurate and easy manufacture of a permanent, everyday oral device for appropriate mandibular repositioning. After this, the links 4 and 5 can be released and removed, and the latching of the ties 12 and 24 freed, allowing the mechanism 3 to be utilised afresh with another patient.

The mandibular-repositioning device of the invention has been found to have major advantages for diagnostic purposes and specification of a permanent aid for treatment of snoring and sleep apnoea. The device described allows a degree of freedom of lateral movement between the patient's jaws, and has been found to give clear evidence of titration both horizontally and vertically while presenting no interference with tongue-space.

1-12. (canceled)

13. A mandibular-repositioning device comprising: first and second parts for engagement with a patient's upper and lower jaws respectively; and an extra-oral mechanism for intercoupling the first and second parts, the extra-oral mechanism comprising selectively-operable ratchet means for effecting incremental change of a displacement of the second part in a forward direction relative to the first part, and wherein the ratchet means comprises a flexible strap having ratchet teeth, and a latching head for latching resiliently with the ratchet teeth, the flexible strap extending through the latching head for incremental advance through the latching head in operation of the ratchet means, and the latching head latching resiliently with successive ones of the ratchet teeth in response to the incremental advance of the strap through the latching head so as to effect the incremental change of displacement of the second part in the forward direction relative to the first part.

14. The mandibular-repositioning device according to claim 13, wherein the extra-oral mechanism comprises: an elongate member for extending extra-orally from the first part, the elongate member having an aperture therein extending lengthwise of the elongate member; and a carrier element located within the aperture, the carrier element being coupled to the second part; and wherein the ratchet means intercouples the carrier element with the elongate member, the ratchet means being selectively operable for drawing the carrier element along the aperture incrementally in effecting the incremental change of displacement of the second part in the forward direction relative to the first part.

15. The mandibular-repositioning device according to claim 14, wherein the elongate member is a rectangular frame, the rectangular frame having longitudinal sides spaced laterally from one another for defining the aperture extending between the longitudinal sides lengthwise of the rectangular frame, and the carrier element extends transversely of the aperture to bear on the longitudinal sides of the frame for retention of the carrier element within the aperture.

16. The mandibular-repositioning device according to claim 14, wherein the carrier element is movable transversely of the aperture to allow lateral displacement of the second part relative to the first part.

17. The mandibular-repositioning device according to claim 14, wherein the carrier element is coupled to the second part via a selectively-adjustable coupling for adjusting spacing between the first and second parts.

18. The mandibular-repositioning device according to claim 17, wherein the selectively-adjustable coupling comprises further ratchet means that is selectively operable for effecting incremental change of the spacing between the first and second parts.

19. The mandibular-repositioning device according to claim 18, wherein the further ratchet means comprises a further flexible strap having further ratchet teeth, and a further latching head for latching resiliently with the further ratchet teeth, the further flexible strap extending through the further latching head for incremental advance of the further flexible strap through the further latching head in operation of the further ratchet means, and the further latching head latching resiliently with successive teeth of the further ratchet teeth upon incremental advance of the further flexible strap through the further latching head so as to effect the incremental change of spacing between the first and second parts.

20. The mandibular-repositioning device according to claim 14 wherein the carrier element has limbs for straddling the aperture.

21. The mandibular-repositioning device according to claim 13, wherein the extra-oral mechanism is selectively detachable from the first and second parts.

22. The mandibular-repositioning device according to claim 13, wherein the first and second parts are trays for engagement with the patient's upper and lower jaws respectively.

23. A mandibular-repositioning device comprising: first and second parts for engagement with a patient's upper and lower jaws respectively; and an extra-oral mechanism for intercoupling the first and second parts, the extra-oral mechanism comprising first selectively-operable ratchet means for effecting incremental change of a displacement of the second part in a forward direction relative to the first part, and second selectively-operable ratchet means for effecting incremental change of a pivotal spacing between the first and second parts, the first and second selectively-operable ratchet means each comprising a flexible strap having ratchet teeth, and a latching head for latching resiliently with the ratchet teeth, the flexible strap extending through the latching head for incremental advance through the latching head in operation of the ratchet means, and the latching head latching resiliently with successive ones of the ratchet teeth in response to the incremental advance of the strap through the latching head so as to effect the respective incremental change.

24. The mandibular-repositioning device according to claim 23, wherein the extra-oral mechanism comprises: an elongate member for extending extra-orally from the first part, the elongate member having an elongate aperture therein extending lengthwise of the elongate member; and a carrier element located within the aperture for sliding along the aperture; wherein the flexible strap of the first ratchet means couples the carrier element to the elongate member via the latching head of the first ratchet means, and the flexible strap of the second ratchet means couples the second part to the carrier element via the latching head of the second ratchet means.
